(19) United States
(12) Patent Application Publication
(10) Pub. No.: US 2010/0062411 A1
(43) Pub. Date: Mar. 11, 2010

(54) DEVICE SYSTEM AND METHOD TO PROVIDE FEEDBACK FOR EDUCATORS

(76) Inventor: Rashad Jovan Bartholomew, Long Beach, CA (US)

Correspondence Address: ST. ONGE STEWARD JOHNSTON & REENS, LLC, 986 BEDFORD STREET, STAMFORD, CT, 06905-5619, US

(21) Appl. No.: 12/555,775

(22) Filed: Sep. 8, 2009

Related U.S. Application Data
(60) Provisional application No. 61/172,742, filed on Apr. 26, 2009.
(60) Provisional application No. 61/095,281, filed on Sep. 8, 2008.

(51) Int. Cl. G09B 7/00

(52) U.S. Cl. 434/350; 434/362

(57) ABSTRACT

A system and method for predicting performance on an assessment and guiding users to take actions to accelerate learning and thereby improve performance on an assessment, as well as providing teacher evaluations, using the Zone of Proximal Development as the driver for understanding the value of prioritizing concepts. Student growth potential is calculated based on concepts most primed for growth as measured by the Zone of Proximal Development and made available to educators and instructors. Concepts are ranked based on priority driven by the ability to impact student growth as assessed in the given concept. Statistics on the relevance of current concepts for future concepts are also calculated and made available.

### CROSS-REFERENCE TO RELATED APPLICATIONS

This patent application claims the benefit of, under Title 35, United States Code, Section 119(e), U.S. Provisional Patent Application No. 61/172,742, filed Apr. 26, 2009, and U.S. Provisional Patent Application No. 61/095,281, filed Sep. 8, 2008, the disclosures of which are incorporated herein by reference.

### FIELD OF THE INVENTION

The invention relates to a system and method for providing feedback for students and educators to optimize the use of instructional time.

### BACKGROUND OF THE INVENTION

An education system usually features similar subject matter taught on several different levels. For example, children introduced to arithmetic at a young age rely on their proficiency of arithmetic to master the fields of algebra and calculus in later years. Predetermined proficiency requirements serve as goals for students. The requirements are usually based on standardized assessments, which serve to measure student proficiency throughout the lifetime of an academic career. Failing to attain certain goals in certain subjects early in an academic career can carry negative effects for related subjects as students advance to more challenging levels. It is thus important to understand and improve upon weaknesses early in an academic career.

With standardized assessments prevalent in many educational agencies, it is vital for students to meet predetermined levels of proficiency in various concepts in order to advance between academic levels. Additionally, teachers and administrators aim to maximize student learning and thereby the amount of students passing standardized assessments as a reflection of the quality of instruction at a given educational institution. Government legislation can also require districts to meet predetermined levels of proficiency. For example, as per the 2001 U.S. No Child Left Behind Act, schools are held accountable for student achievement levels and penalties are issued for schools that do not make adequate yearly progress toward meeting the goals of the Act. As a result, the state of California has adopted an Academic Performance Index growth target to measure the progress of its schools in standardized assessment performance. For educational agencies such as that of California to meet predetermined levels of proficiency, discovering areas with the most growth potential for student proficiency is crucial towards achieving academic progress.

Advances in educational technology have allowed students and educators to achieve more in the classroom. However, ascertaining a clear understanding of academic strengths and weaknesses at an early level remains vital to obtaining an efficient, comprehensive understanding of academic concepts.

Educational data analysis in a student-educator community aims to make learning and teaching more effective and convenient. Prior educational data analysis systems such as educational data management systems and databases for recording and reporting test performance provide certain benefits to educators. However, while such prior systems provide historical data to the educator, they do not provide specific guidance to educators and students as to how to best attain required levels of performance. Therefore, what is desired is an educational data analysis system that provides specific guidance to educators and students as to how to best optimize learning opportunities to attain required levels of performance.

### SUMMARY OF THE INVENTION

It is an object of the disclosed system and method to accelerate learning, predict test performance, and guide users to take actions to improve performance using the Zone of Proximal Development as the driver for understanding the value of prioritizing concepts. The disclosed system and method assesses the Zone of Proximal Development through an analysis of the time value of instruction, to best locate the concepts best positioned for efficient assimilation.

It is a further object of the disclosed system and method to calculate student growth potential and maximize student growth by informing educators and students of the concepts most primed for growth, determining said concepts by calculating the size of the Zone of Proximal Development for each concept.

It is a further object of the disclosed system and method to rank the priority of concepts which a particular student would need to improve in order to increase proficiency. In one embodiment, the system can rank the priority of concepts which a particular student or group of students, or a class, school, or district would need to improve in order to accelerate learning and increase proficiency. By providing statistics such as the name of the concepts, the level of performance in said concept, the number of questions concerning the concept on an upcoming assessment administered by a testing authority, and the number of times the concept is or has been tested, a student or instructor can understand and pinpoint the concepts which a student needs to improve more urgently and comprehensively than others. Ranking such priority of improvement keeps teaching in the Zone of Proximal Development, making teaching more efficient and effective to maximize student growth.

It is a further object of the disclosed system and method to provide statistics and analysis concerning a predetermined level of performance. Such statistics can help instructors and administrators understand a student's or class' or local education agency's progress beyond a current level of study. By providing analysis as to whether a student or class is on track to reach a predetermined level of performance, the system aids instructors and administrators to make teaching adjustments continuously throughout early in a period of learning.

It is a further object of the disclosed system and method to identify students and corresponding concepts having a strong chance of improvement and alignment between a current concept of study and an upcoming concept. By identifying and highlighting such alignment, thereby marking vertical alignment between concepts, a user can be alerted and encouraged to increase time and effort in a particular area for future success in the highlighted area on an upcoming concept.

It is a further object of the disclosed system and method to identify concepts that are the most relevant for future assessments administered by an educator or testing authority. In order for a student to maximize his or her growth potential, the student must be able to become proficient or master concepts which are tested at future levels. By becoming proficient and mastering precursors to future-tested concepts at an early age, a student is able to perform better on said future-tested concepts. Displaying concepts that are relevant for future assessments and calculating such relevance helps students maximize future performance.

It is a further object of the disclosed system and method to provide feedback and display statistics for student performance, class performance, and performance of a local education agency. In one embodiment, this includes a school, a district, and/or a state.

It is a further object of the disclosed system and method to give teachers detailed information about expected class scores on assessments administered by an educator and the most statistically beneficial course material to teach a class in order to improve the overall class scores on assessments administered by an educator. If the students in a class are not up to par on preceding concepts, alerting a teacher to problems a teacher may have teaching the current concept to a class helps a teacher understand how to rectify said problems. In one embodiment, assessment scores are normed to the scores of a given state, providing teachers and students with a clear picture of current performance from which future projections may be derived with the goal of accelerating learning and thereby improving scores on assessments administered by a state testing authority.

It is a further object of the disclosed system and method to provide teacher evaluations based on student growth as measured through written or verbal assessments. Evaluations of concepts can help a teacher know the concepts in which the students have grown far more than average than other teachers that have taught the same concepts, in addition to those concepts that the teacher instructed less effectively if the students of the teacher grew significantly less than average.

It is a further object of the disclosed system and method to provide timely feedback on student performance, provide a virtual locker for educators, and supply a means to share such content with members of a teacher's network. Feedback may be displayed using line graphs, pie charts, or bar charts. In one embodiment, an interactive website may be used to display feedback and allow a user to view statistics, trends, and forecasted performance.

The methods of the disclosed system and method promote the learning of students and effectiveness of educators. The software according to the disclosed system and method creates an assessment tool that allows educators to make concept-based assessments. This facilitates an educator's understanding of a state's academic standards and facilitates an improvement in teaching decisions to maximize student learning.

The software and methods according to the disclosed system and method form an adaptive teaching tool. Rather than relying on discrete curricula or raw data, the adaptive teaching tool emphasizes generating timely feedback on data and from that data, providing information that can be used to increase teaching effectiveness. The Zone of Proximal Development serves as the driver for providing such results and forecasting future performance. Student and class test scores are forecasted in order to make the student and instructor aware of trends and progress. An instructor is able to adapt the teaching technique responsive to the projected performance of a student and tailor future instruction towards increasing the level of a student's performance at present and future levels.

It is a further object of the disclosed system and method to recommend groups to teachers or to enable a teacher to create groups based on student performance and growth potential. A group learning application can allow the teacher to create groups in order to increase the proficiency of a given concept. If a teacher creates balanced groups, students can benefit from a diversity of knowledge or cooperative learning; the groups would include both students that have mastered a concept and students that need more help understanding a concept. If a teacher creates hierarchical or differentiated groups, students can benefit by learning in groups that match students with similar levels of skill on a given concept. Both balanced groups and hierarchical groups can increase a student's learning of a given concept.

It is a further object of the disclosed system and method to provide longitudinal analysis of a student's performance. Longitudinal analysis involves issuing a performance rating to a student as the student completes each concept. Performance ratings begin as updates on the concept and become part of the longitudinal record as a student passes on to new material. These performance ratings can be aggregated and disaggregated by concept at all levels including student, class, and local education agency levels. By keeping track of performance ratings for students, the system can inform users of precisely where the learning gaps are from prior years and alert all stakeholders including parents, teachers, students, and administrators to individual and group learning gaps. Longitudinal analysis increases awareness about student needs and what problems they may have with a given concept over a unit of time. Students and parents will be empowered to seek help through various means and resources to perform at the target grade level.

It is a further object of the disclosed system and method to provide an educator with a graphical breakdown of student performance in a given class or concept at the individual student level, class level, or local education agency level. An instructor, upon viewing the concepts indicated at each performance band, will be able to determine which concepts require the most attention and improvement. Upon doing so, an instructor can not only increase the students' understanding, but his or her own success in teaching the concepts.

The system according to the disclosed system and method also includes software for a user to “drill down” in a particular concept. For example, upon viewing a collective performance rating for the concept of mathematics, a user can click on the mathematics button to view the performance rating for different concepts covered in the concept of mathematics. This allows an instructor to have increased knowledge of specific concepts, thereby improving efficiency of teaching and accurately depicting the best opportunities for learning.

It is a further object of the disclosed system and method to display forecasted test scores for various groups or subgroups. In one embodiment, the subgroups include all ethnic subgroups, students listed as socio-economically disadvantaged, students with disabilities, and students who are classified as “English Learner.”

It is a further object of the disclosed system and method to test students frequently in order to ascertain several different samples of test aptitude and thereby forecast test scores more accurately.

Other objects of the invention and its particular features and advantages will become more apparent from consideration of the following drawings and accompanying detailed description.

### BRIEF DESCRIPTION OF THE DRAWINGS

FIG. 1 is an image of a student dashboard, showing forecasted class test score, trends in a particular concept, and options for viewing statistics of a particular subgroup.

FIG. 2 is an image of a student in a class dashboard, displaying growth standards for a particular student.

FIG. 3 is an image of a class dashboard, displaying the students in a class, their performance rating based on proficiency percentage, buttons to view growth standards, a graph of the number of students in each performance band, forecasted test score improvement, and growth standards for the class.

FIG. 4 is an image depicting the “drill-down” function, whereby a user can view “subject breakdowns” (concept breakdowns) for a particular subject, in addition to preceding and upcoming standards, or concepts, and their respective alignment (“vertical alignment”). An upcoming concept with perfect vertical alignment to the current standard is highlighted in red.

FIG. 5 is an image depicting the preceding and upcoming concepts along with “growth students,” identifying the students in a particular group that, based on their unique profile of strengths and weaknesses would most likely value a lesson on the given concept.

FIG. 6 is an image displayed when groups are selected, demonstrating balanced groups.

FIG. 7 is an image of priorities in a given concept. Concepts with the best time value of instruction, which are categories most optimally balanced between room for growth and the zone of proximal development, are listed at the top with priority ranking, the number of questions on an upcoming assessment administered by a testing authority, and the number of times tested.

FIG. 8 is an image of a school dashboard and its professional development, displaying the instructors in a school, performance rating, concept, and a button to view mastery/opportunity concepts.

FIG. 9 is an image displaying mastery and opportunity concepts for an instructor, where an instructor may learn the concepts which teaching resulted in underachieving students or teaching that resulted in students that have a strong level of proficiency.

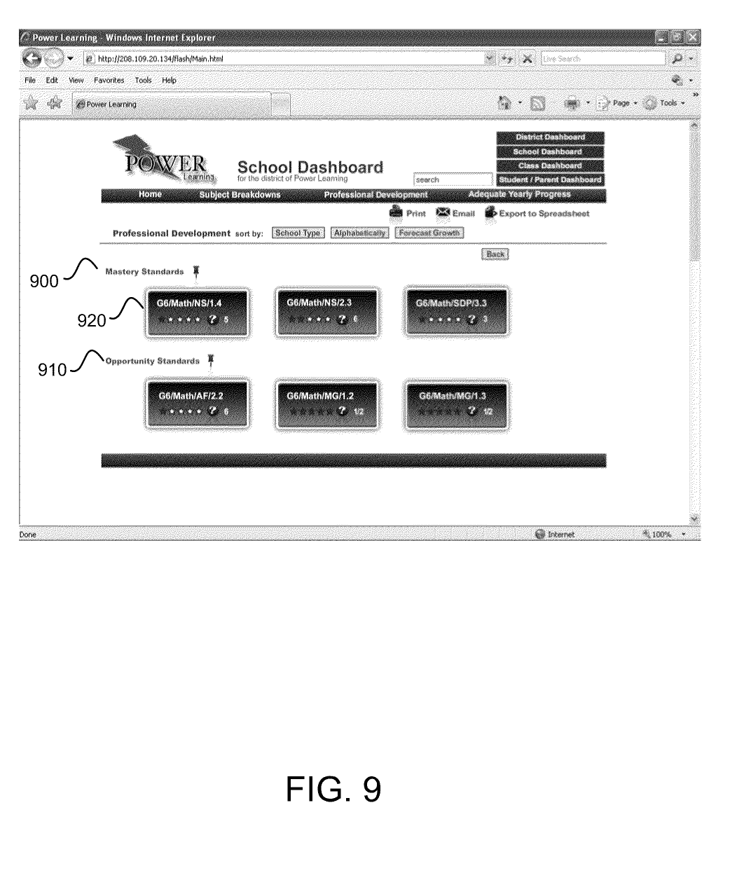

FIG. 10 is an image displaying the Adequate Yearly Progress (AYP) for a particular school. The system determines whether a school is likely to make AYP, or another a predetermined level of performance, and displays statistics embodying this determination.

### DETAILED DESCRIPTION OF THE INVENTION

The disclosed system and method provides a system and method for guiding users to take actions to improve test performance, as well as providing teacher evaluations, and using data to actively direct user actions using the Zone of Proximal Development as the driver for understanding the value of data-based recommendations.

Testing frequently and providing timely feedback to students and educators heightens awareness of academic strengths and weaknesses, allowing for earlier improvement and recognition of growth potential. Reporting statistics concerning the Zone of Proximal Development for certain concepts can help a student or educator recognize specific areas of growth potential. A theory developed by psychologist Lev Vygotsky, the Zone of Proximal Development represents the difference between achievement ascertained with help and achievement ascertained without help. Solving problems independent of outside help serves as an indicator for teachers in determining a student's progress. The larger the zone, the more progress that is achievable. Assessing the best way to minimize this difference, or recognizing the largest such zone, is instrumental for overcoming academic deficiencies or utilizing academic strengths. Identifying areas of improvement through analysis of the Zone of Proximal Development can help a student avoid difficulties in certain concepts in an upcoming level. Statistics and forecasted scores based on the Zone of Proximal Development can help teachers instruct students properly in order for the students to reach their highest learning potential.

The system provides student and teacher evaluations based on student achievements on frequent diagnostic assessments administered by an educator or testing authority. Past performance is used to generate and display on a computer a performance rating for a student and a forecast of future performance. Learning is quantified through calculation of student growth, or the proficiency percentage that a student can improve over a given amount of time. An educator, such as a teacher or administrator may view the concepts in which the students of a particular teacher have grown far more than average than students of other teachers that have taught the same concepts, in addition to those concepts that the teacher might need help in as the students of the teacher grew significantly less than average.

The system provides potential growth statistics through calculation of previous academic performance, the room for improvement, and the Zone of Proximal Development. A diagnostic assessment administered by an educator or testing authority provides a starting percentage per student based on the assessment of past knowledge and its correlation with learning in the next assessment period. A final percentage per student is included in the system, indicating the percentage of correct responses necessary to achieve a required level of proficiency or mastery. The potential for growth, as derived from the quantification of the Zone of Proximal Development, constitutes a focus rating F. The system ranks priorities of study in order for users to know which concepts require the most attention. To ascertain a value of priority V, several factors are considered in the calculation. A contribution margin M is calculated by multiplying the number N of questions on a concept on an upcoming assessment by the expected percentage P of correct answers on said concept on said upcoming assessment. Room for growth G is calculated by subtracting the number M, the contribution expected from the concept on the upcoming assessment from N, the number of questions on the concept, or N-M, which equals G. The value of priority V is then calculated by multiplying the room for growth G by the focus rating F. Once the value of priority V is calculated for a concept, the system can rank concepts in order of their corresponding value of priority V, thereby informing users of the concepts which require the most attention. Thus, the system prioritizes the concepts in which a student will most efficiently assimilate knowledge per unit of time as calculated from the room for growth and the Zone of Proximal Development, thereby informing the user of the concepts which should be given a higher level of attention. Once a user is informed of the concepts of highest priority, the user may focus attention to said concepts, maximizing the student's chances of attaining proficiency or mastery of a certain concept.

In this system, frequent testing allows calculation of growth over time, which is a weighted average of a number of past performances. For example, an initial test produces a diagnostic result, and a second test is known as the first formative assessment result. Until a third test is given, the second test serves as the sole indicator of growth over time. Once a third test is given, the second formative assessment result can be ascertained. At this point, expected test performance is calculated by summing a primary percentage, for example, 80%, of the second formative assessment result with a secondary percentage less than the primary percentage, for example, 20%, of the first formative assessment result. Once a fourth test is given, the third formative assessment result can be ascertained. With three formative assessment results available, expected test performance is calculated by summing a primary percentage, for example, 75%, of the third formative assessment result, a secondary percentage, for example, 20%, of the second formative assessment result, and a tertiary percentage less than the secondary percentage, for example, 5%, of the first formative assessment result. Once a fifth test is given, the fourth formative assessment result can be ascertained. At this point, expected test performance is calculated by summing a primary percentage, for example, 75%, of the fourth formative assessment result, a secondary percentage, for example, 20%, of the third formative assessment result, and a tertiary percentage, for example, 5%, of the second formative assessment result. The first formative assessment result is no longer factored into the calculation of growth over time. The average expected performance from each of the previous steps is recording to show the growth trend over time. This trend continues with each new formative assessment; the expected performance on an upcoming concept is calculated by summing a primary percentage of the most recent result, a secondary percentage of the next most recent result, and a tertiary percentage of the third most recent result. Aggregating the current average of all concepts at any point in time provides forecasted assessment performance.

The system also uses statistics from diagnostic tests to project an average expected score at an upcoming grade level. A projected score is determined by finding the average level of performance on the diagnostic for each preceding concept. Each preceding concept has a correlative relationship to grade level concepts. Grade level concept averages are determined by taking the weighted average of the preceding concepts, where the correlative relationship between grade level concepts and predecessors serves as the weighing mechanism. For example, if a grade level concept has two predecessors and the first predecessor has an average of 50% and a correlative relationship quantified as 2 with the grade level standard and the second predecessor has an average of 75% and a correlative relationship quantified as 1 with the grade level standard, the weighted average of the two predecessors is taken, multiplying 2 by 0.5 and 1 by 0.75. The two values are then aggregated and subsequently divided by the combined weight of 3. The average expected score for a grade level assessment can be found by a similar process where the weighted average of all grade levels concepts is aggregated and the number of questions on the assessment for each concept serves as the weighing factor.

The system also measures the relevance of specific concepts to concepts tested at the next level (e.g., next grade level). The system uses an upcoming standard correlation value C to find the value R for how relevant the specific concept is to the next level. The system sums the products of a fraction N (where N represents the number questions on a specific concept on an upcoming assessment administered by a testing authority divided by the total number of questions on an upcoming assessment administered by a testing authority, and the upcoming standard correlation C for each question. The upcoming standard correlation C is determined by an instructor using the system; the higher the value of C, the more closely correlated the specific concept is to the upcoming concept. For example, an instructor can use a value of 3 for C to represent a strong correlation, a value of 2 for C to represent an intermediate correlation, and a value of 1 for C to represent a weak correlation. The sum of all N*C products for a preceding concept gives a value R, representing how relevant the specific concept is to learning at the next level. The system then ranks specific concepts by the R value in order to indicate to the user the relevance of specific concepts to concepts tested at the next grade level. Relevance may be calculated as a static, one-time calculation, provided the N and C values of a set of standardized assessments do not change (although the assessments might change in other respects). Thus, if the N or C values change for a set of standardized assessments administered by a testing authority, then the relevance may require recalculation.

The system also calculates relevance for levels (e.g., grade levels) past the next level as well. This helps users understand which concepts are most important for knowledge across several different levels. In order to calculate such multilevel relevance, the system uses a base R value, representing how relevant the specific concept is for next year's learning. Using this as a base value, the system adds to the R value the sums of all N*C products available between two consecutive levels for a specific concept. For example, to calculate the relevance of a specific concept taught in a 2^{nd} level (e.g., 2^{nd} grade) and present in an assessment given in a 5^{th} level (e.g., 5^{th} grade), the R value would be the sum of all N*C products for said specific concept between 2^{nd} level and 3^{rd} level, 3^{rd} level and 4^{th} level, and 4^{th} level and 5^{th} level. The higher the R value, the more relevant the specific concept is for a level past the upcoming level.

The system evaluates teachers by identifying mastery concepts and opportunity concepts. Mastery concepts include standards where the teacher outperformed a predetermined number of other teachers (e.g. 90%), as measured by student growth. Opportunity standards, on the other hand, are concepts where the teacher underperformed a predetermined number of other teachers (e.g., 75%), as measured by student growth. To calculate professional development, the system measures student growth at grade level at all ends of the performance spectrum. Teachers are evaluated by whether the students of the teacher achieved growth above an average growth or below an average growth. In order to normalize the professional development statistics, growth is adjusted for proximity to the ends of a measurable range at grade level.

In one embodiment, the system features four “dashboard” user interfaces, which may be implemented in a website or another suitable implementation. The dashboards display results, statistics, trends, and projections and can include student, class, school, and district dashboards. The student dashboard contains performance ratings and forecasts of future performance for an individual student. The class dashboard displays the students in a class, forecasted scores for students, groups of students, and a ranking of priorities. The school and district dashboards (“local education agency” dashboards) display concepts, teacher evaluations, and chances of attaining a predetermined level of performance.

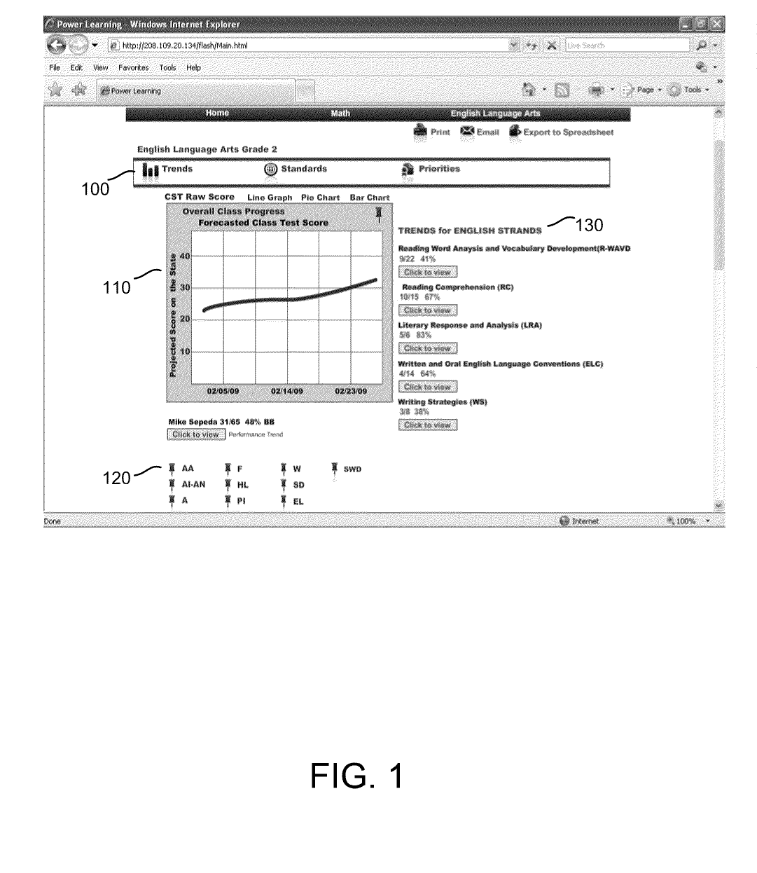

As shown in FIG. 1, the “student” dashboard will allow the user to view a menu bar 100 of trends, standards, and priorities regarding the particular student's assessment results in a variety of concepts. On the home page, scores are forecasted in a chart 110 for future assessments administered by an educator or testing authority. Additionally, trends 130 for specific concepts can be viewed. Statistics and forecasted scores for subgroups 120 are viewable; subgroups include but are not limited to ethnic subgroups, socioeconomically disadvantaged subgroups, subgroups of students with disabilities, and subgroups of students classified as “English Learner.” On the trends page, assessment scores are forecasted for various intervals for several different concepts, such as at intervals of one year. Intervals may be specified by the instructor administering the tests or by a testing authority; the system does not require limits on the frequency of testing. On the standards page, the user can view the number of questions dealing with a particular concept on an upcoming assessment administered a testing authority, the relevance of that concept for future assessments administered by a testing authority, and the priority of immediate growth potential for the student in that concept. On the priorities page, the user may view a complete list of concepts, with their corresponding performance rating reflective of the level of proficiency, priority ranking, number of questions on an upcoming assessment administered by a testing authority, and the number of times that concept is tested.

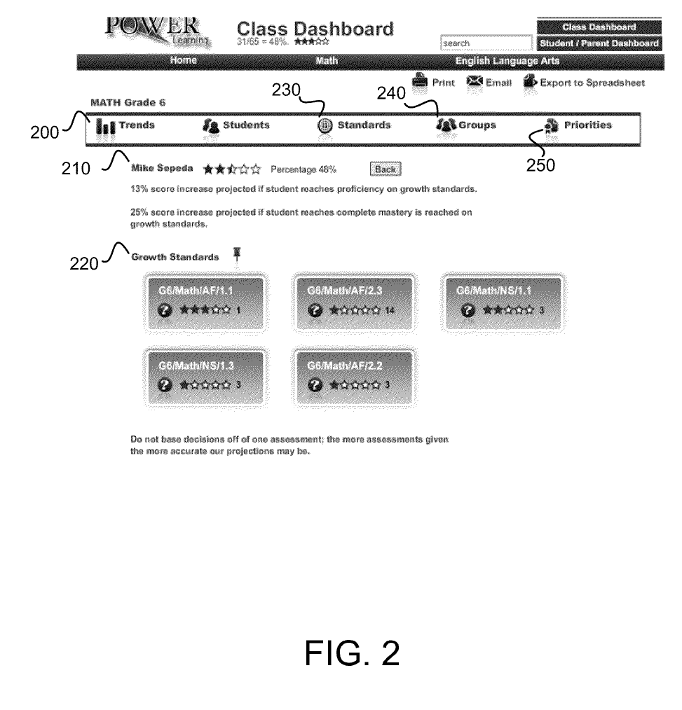

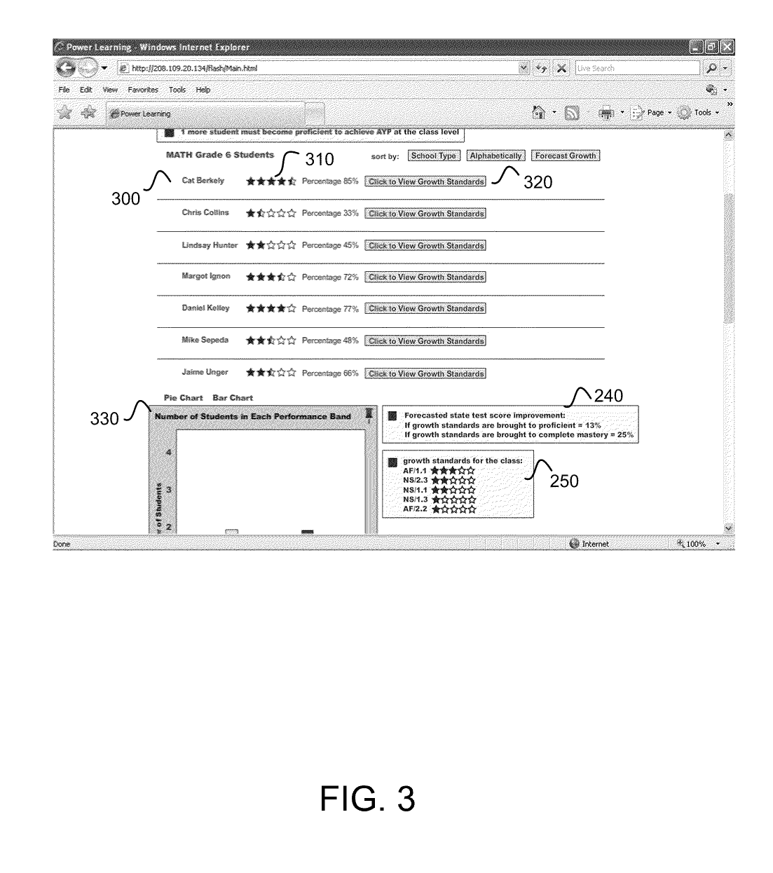

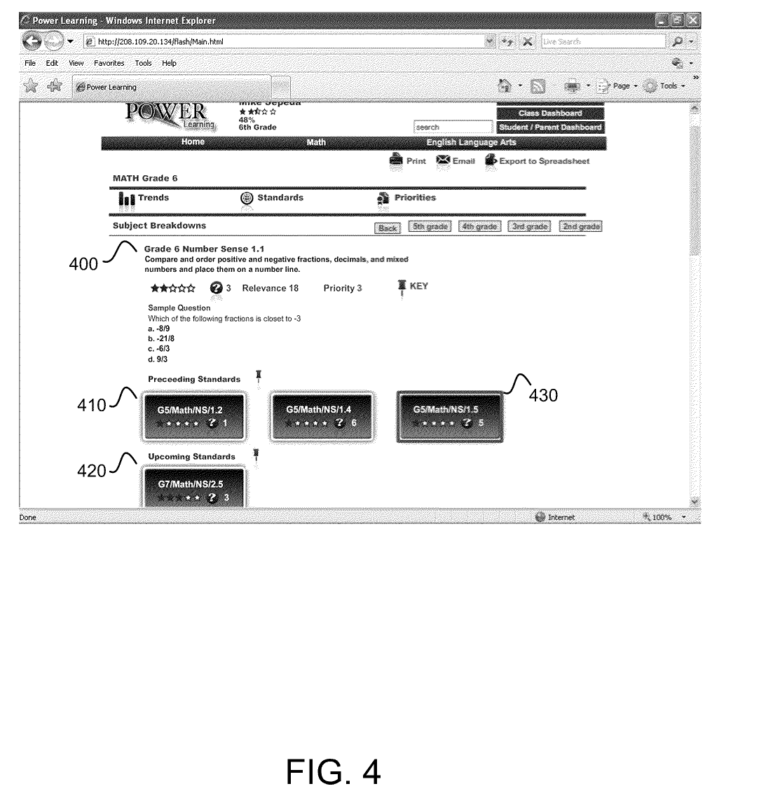

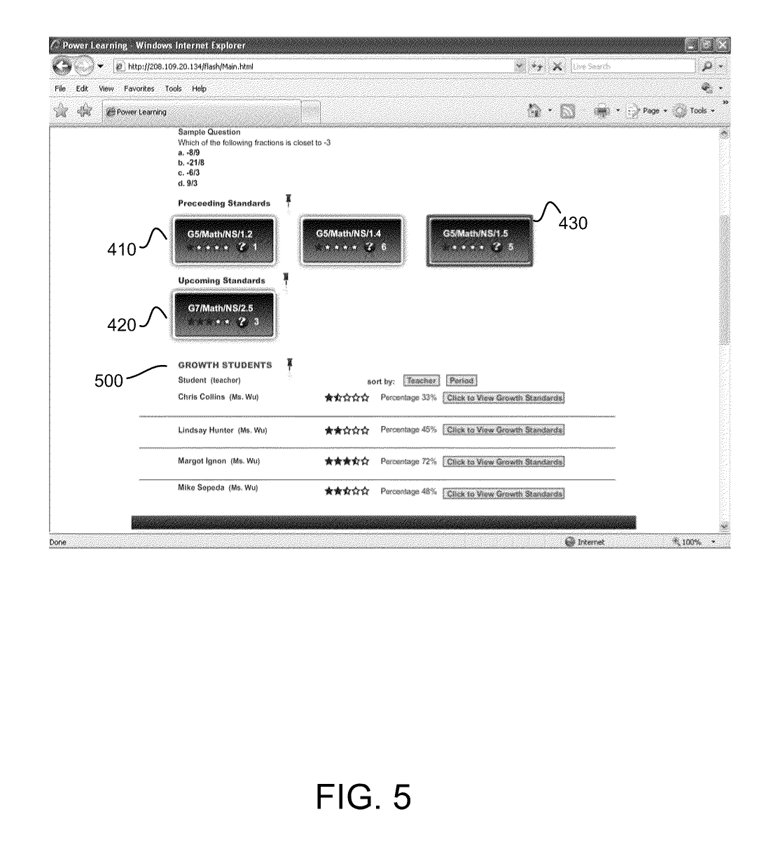

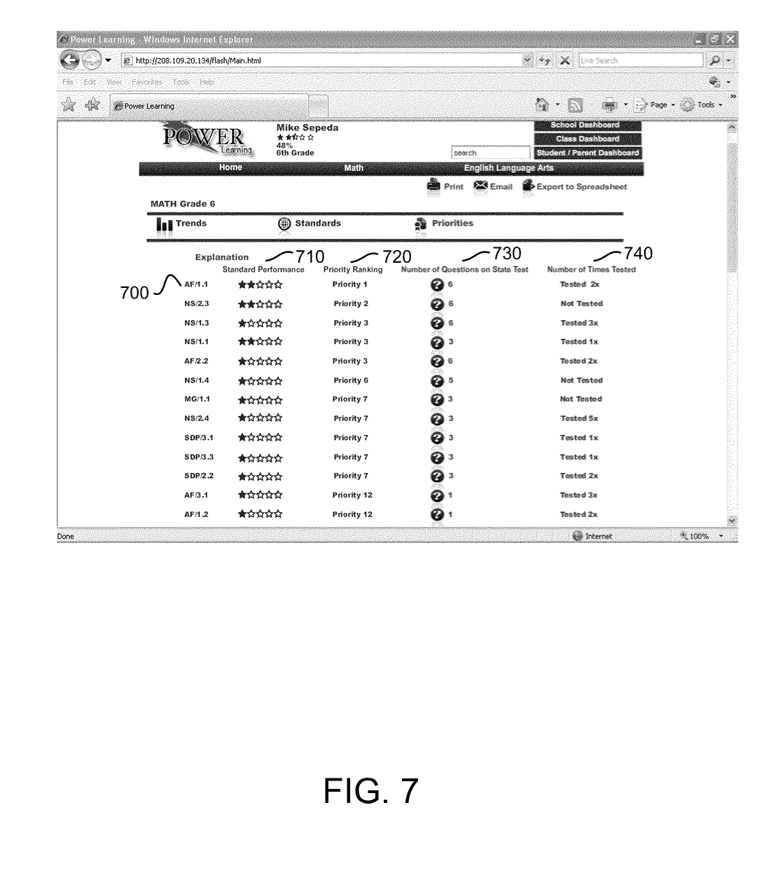

As shown in FIGS. 2-7, the “class” dashboard allows the user to view the performance for a certain class, broken down by the number of students at a certain performance band. A menu bar 200 allows a user to select trends, students, standards 230, groups 240, or priorities 250. On the trends page, class performance overall, or for a particular concept is viewable in line, pie, or bar chart format. In addition, the class performance of a numerical significant subgroup (NSS) may be viewed by specifying the subgroup. On the students page, a list 300 of students in a class is provided, with a graph of the number of students in each performance band, forecasted future test improvement based on growth standard (proficient, complete mastery, etc.), and options for viewing concepts of potential growth, or growth standards 220, for each individual student in the class. Selecting one student 210 in the class can display statistics for the selected student. An alert is provided to inform the user of the number of students needing to become proficient to achieve Adequate Yearly Progress (AYP), or another a predetermined level of performance, at the class level.

On the standards page in the “class” dashboard, similar to the standards page in the “student” dashboard, the user can view the number of questions 730 dealing with a particular concept on an upcoming assessment administered by a testing authority, the relevance of said concept for future assessments administered by a testing authority, and the priority of growth potential for the student in said concept. To reflect a student's or class' Zone of Proximal Development, the standards page displays the drilled-down concept 400, preceding concepts 410, upcoming concepts 420, and growth students 500. The preceding concepts 410 display identifies concepts from the previous level most closely correlated to the current particular concept, while the upcoming concepts 420 display identifies a predetermined number (e.g., three) concepts from the next level most closely correlated to the current particular concept. A preceding or upcoming concept is outlined in red 430 to signify perfect vertical alignment with the current particular concept. Perfect vertical alignment signifies direct correlation between the subject matter of the current particular concept and the outlined concept, that is, the subject matter of the current particular concept is included as a subset in the subject matter of the outlined concept. Teachers and other educators can view the preceding and upcoming concepts, along with indications of perfect vertical alignment, so that they may understand their own range of teaching. The display of concepts, priorities, and growth students helps a teacher understand the student's or class' Zone of Proximal Development and thus allows educators to maintain teaching within the proper learning range and focused on the most relevant concepts with the highest priority for student learning growth.

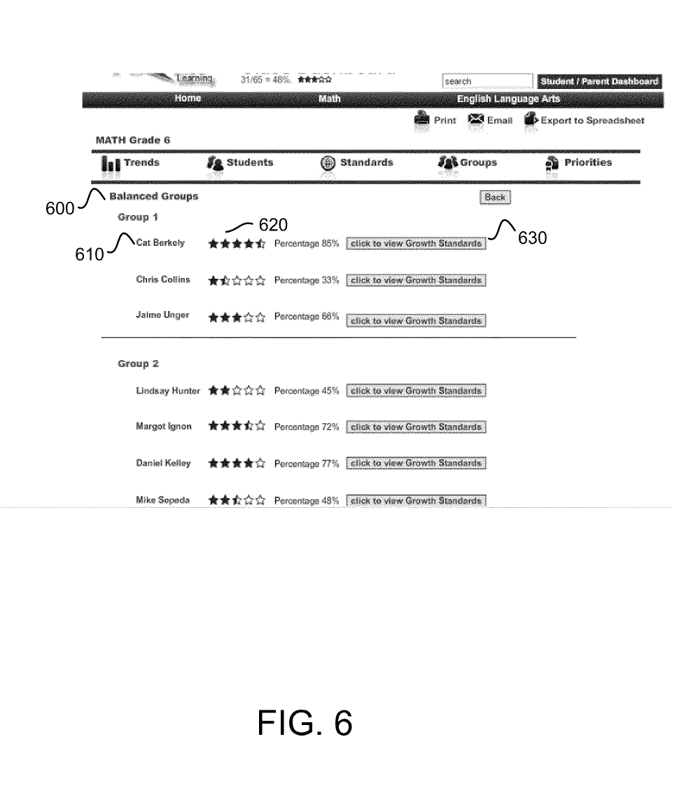

Also found in the “class” dashboard are statistics regarding groups of students. By visiting the Groups page, shown in FIG. 6, the user can view either balanced (heterogeneous) 600 or striated (homogeneous) groups; heterogeneous groups provide for the performance averages of the selected number of students 610 to be the same for cooperative learning, while the homogeneous option creates groups that each feature similar students in terms of performance for differentiated learning. Present on the groups page is a performance rating 620 for each student and a button 630 to view Growth Standards. Additionally, the “class” category features a priorities page is similar to the priorities page in that the “student” category, whereby the user may view a complete list of concepts 700, with their corresponding performance rating 710, priority ranking 720, number of questions on an upcoming assessment administered by a testing authority 730, and the number of times that concept is tested 740.

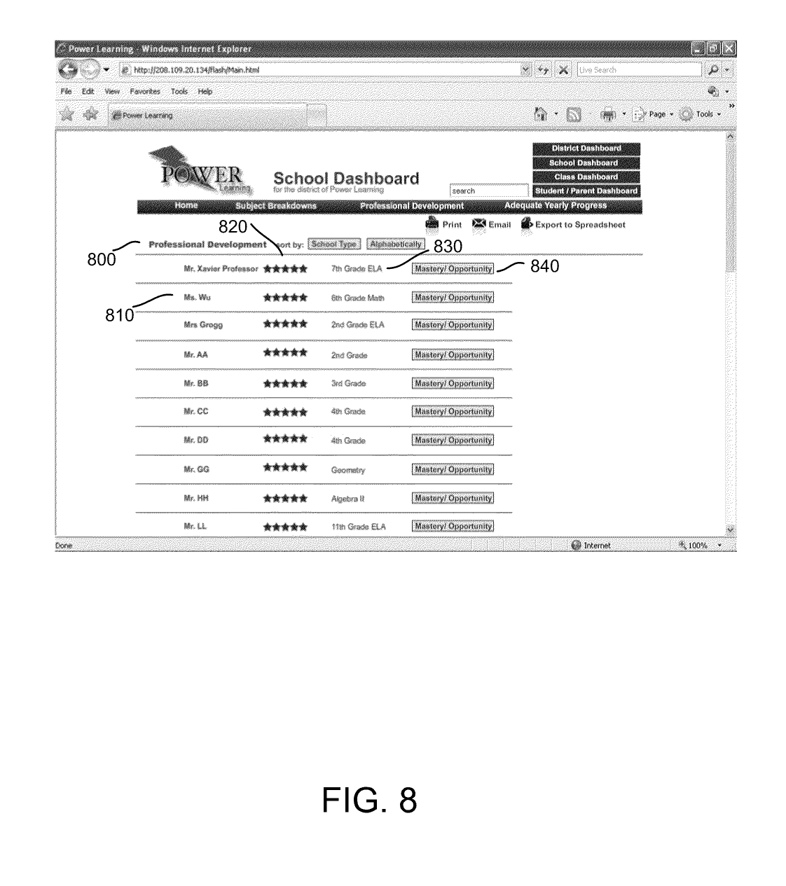

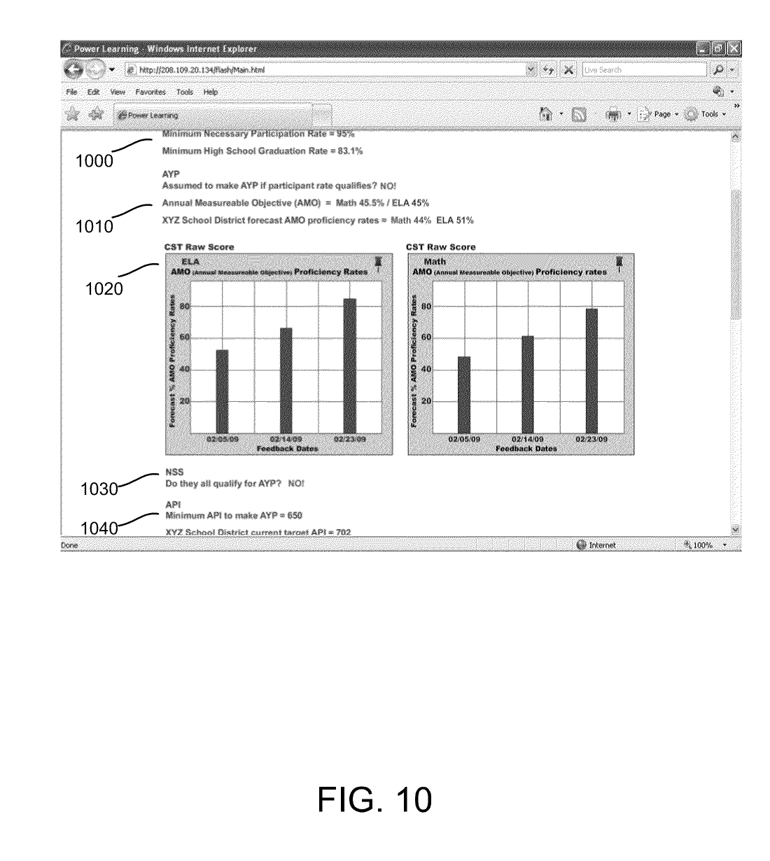

Choosing a “local education agency” dashboard will allow a user to view statistics on three different pages: subject breakdowns, professional development, and in one embodiment, AYP. On the subject breakdowns page, a list of all tested classes on all levels is listed, with performance ratings for each. The user can view the classes, performance trends, and concepts (students and priorities are a part of this view) for a particular level. On the professional development page, as in FIG. 8 and as identified at the top of the page 800, the user can view a performance rating 820 for a particular teacher 810. Choosing “mastery/opportunity” 840 for a particular teacher displays a set of concepts in which the teacher has above-average student growth 900 as well as below-average student growth 910 while displaying the performance rating for a particular concept 920. In this particular embodiment, a user can view statistics concerning AYP, a state's Academic Performance Index (API) 1040 and Annual Measurable Objective (AMO). On the AYP page, as in FIG. 10, the user can view the AYP ratings of a particular school, as well as statistics concerning the state's API 1040 and AMO 1010. Statistics include a representation of proximity from a predetermined level of performance. The page reports the participation and graduation rates 1000 of a school, proficiency percentage levels for state standards 1020, and determines whether all the concepts are qualifying for AYP 1030. Users can use the AYP page to drill down and locate students in different levels of proximity from AYP.

Statistics concerning growth and relevance are reflected frequently throughout the invention. The Zone of Proximal Development identifies how a student's performance in a particular concept may grow. Calculating how quickly a student is able to make up the learning gap as indicated by data is done using the Zone of Proximal Development, which is used to give an account of the rate of a student's learning on a given concept. When scores are not available, then historical data or in house approximations will be used.

In one embodiment, the system and method includes a personal computer for calculation and display of statistics. Users input values including student assessment scores, class statistics, correlation values, and information concerning concepts into the database present on the personal computer. The stand-alone personal computer performs the aforementioned calculations and displays to the user the appropriate statistics, trends, and forecasts. The user is thus able to view the results of the calculations on the monitor of the personal computer.

In another embodiment, the system and method includes a plurality of computing devices interconnected by a network, such as a local area network, a wide area network, or the Internet, or a combination of such networks. At least one computing device serves as a data entry device and receives input values from the user, including student assessment scores, class statistics, correlation values, and information concerning concepts and loads the inputted information into a database. At least one computing device serves as a database device, storing the inputted data. At least one interconnected computing device serves as a calculation device, performing the aforementioned calculations of appropriate statistics, trends, and forecasts. Upon completing the calculations, at least one interconnected computing device functions as a display device, displaying to the user the appropriate statistics, trends, and forecasts. The display device may receive display data from a web server or another suitable source of display data. A plurality of the said computing devices may be combined into one computing device.

Although the invention has been described with reference to a particular arrangement of webpages and statistics, these are not intended to exhaust all possible arrangements or displays, and indeed many modifications and variations will be ascertainable to those of skill in the art.

What is claimed is:

1. An educational data analysis system, comprising:
a computing device;
a computer database for storing student data;
means for calculating growth potential of a student by computing a difference between an absolute or expected proficiency percentage and a current proficiency percentage;
means for calculating growth over time by tracking progress across a plurality of concepts evaluated through past formative assessment results;
means for calculating relevance of concepts by utilizing factors of correlation with upcoming concepts and a value placed on upcoming concepts by assessments as measured by a frequency of testing of said upcoming concepts; and
means for prioritizing each concept according to potential timely performance growth, based on the Zone of Proximal Development, and the frequency of testing of said concepts.

2. The system according to claim 1, further comprising:
a student interface for displaying student statistics.

3. The system according to claim 2, further comprising:
means for displaying trends, concepts, and priorities based on assessment results of a student for a variety of concepts.

4. The system according to claim 2, further comprising:
means for forecasting assessment scores for various intervals for several different concepts.

5. The system according to claim 2, further comprising:
means for displaying a number and type of questions on an upcoming assessment for a concept, and immediate growth potential for the student in said concept based on a calculated Zone of Proximal Development for the student.

6. The system according to claim 2, further comprising:
means for providing longitudinal analysis to a user by recording performance on preceding concepts, displaying performance on a preceding concept, and displaying growth statistics over time of the student.

7. The system according to claim 6, further comprising:
means for highlighting a preceding or subsequent concept to signify direct correlation between the current concept and said preceding or subsequent concept.

8. The system according to claim 2, further comprising:
means for displaying a list of concepts, and for each listed concept, a corresponding performance rating, number of questions on an upcoming assessment and a number of times that each listed concept has been tested over a period of time.

9. The system according to claim 2, further comprising:
means for evaluating and projecting student performance as individuals or in groups.

10. The system according to claim 1, further comprising:
a class interface for storing and displaying class statistics.

11. The system according to claim 10, further comprising:
means for displaying a performance for a certain class.

12. The system according to claim 11, further comprising:
means for displaying bands of performance representative of a number or percentage of students in a class achieving a certain performance level.

13. The system according to claim 10, further comprising:
means for displaying overall class performance and trends in a graphical format.

14. The system according to claim 10, further comprising:
means for displaying concept-specific class performance and trends in a graphical format.

15. The system according to claim 10, further comprising:
means for displaying collective performance of a group or subgroup.

16. The system according to claim 10, further comprising:
means for displaying a list of students in a given class; and
means for displaying a performance rating and a percentage of correct responses for each of said students.

17. The system according to claim 10, further comprising:
means for forecasting test improvement of a class based on a standard of growth determined by performance on concepts that are both deemed important on the assessment but tempered with a higher level of the Zone of Proximal Development.

18. The system according to claim 10, further comprising:
means for displaying forecasted test improvement based on a potential growth determined by the Zone of Proximal Development of each individual student in the class.

19. The system according to claim 10, further comprising:
means for displaying a number and type of questions on an upcoming assessment for a concept; and
means for indicating a priority of immediate growth potential for the class in said concept based on the Zone of Proximal Development of the class.

20. The system according to claim 10, further comprising:
means for providing longitudinal analysis to a user by tracking performance of preceding concepts across time and predicting performance on a concept subsequent to a current concept, displaying performance on preceding concepts, and growth statistics over time of a class.

21. The system according to claim 20, further comprising:
means for determining a number of students that would need to improve performance a least amount to become proficient in order to achieve a predetermined level of performance at the class level.

22. The system according to claim 20, further comprising:
identifying growth students that would need to improve performance a least amount to become proficient in order to achieve a predetermined level of performance at the class level; and
means for displaying a forecasted test score improvement in percentage form if said growth students achieve a proficient performance level.

23. The system according to claim 22, further comprising:
means for displaying a forecasted test score improvement in percentage form if said growth students achieve a complete mastery performance level.

24. The system according to claim 20, further comprising:
means for displaying concepts where collective growth is most possible for the class.

25. The system according to claim 20, further comprising:
means for providing longitudinal analysis to a user by predicting performance on a concept subsequent to a current concept, displaying performance on a concept preceding the current concept, and growth statistics over time of the class.

26. The system according to claim 20, further comprising:
means for highlighting a preceding or subsequent concept to signify direct correlation between the current concept and the said preceding or subsequent concept.

27. The system according to claim 20, further comprising:
means for displaying a list of students that are best positioned to grow and would thus most value a concept based on individual strengths and weaknesses and displaying a performance rating and a percentage of correct responses for said students.

28. The system according to claim 10, further comprising:
means for displaying student performance in group form, wherein said group contains students having either the same collective performance average among students in said group, or said group contains students with similar individual performance.

29. The system according to claim 10, further comprising:
means for displaying a list of concepts, and for each listed concept, a corresponding performance rating, number of questions on an upcoming assessment and the number of times that each listed concept has been tested over a period of time.

30. The system according to claim 1, further comprising:
a local education agency interface for displaying local education agency statistics.

31. The system according to claim 30, further comprising:
means for displaying a list of all students in a local education agency, a list of all tested classes on all grade levels in a local education agency, with performance statistics for each class.

32. The system according to claim 31, further comprising:
means for displaying performance trends for a concept on a level.

33. The system according to claim 30, further comprising:
means for evaluating teacher performance based on student and class performance; and
means for displaying a performance rating for a selected teacher based on student growth, said student growth normed to an average student growth.

34. The system according to claim 33, further comprising:
means for displaying a set of concepts for which a teacher has instructed students achieving above-average student growth and for displaying a set of concepts for which a teacher has instructed students achieving below-average student growth.

35. The system according to claim 30, further comprising:
means for displaying a representation of a proximity to a predetermined level of performance for a particular school, district, or other local education agency.

36. A system for educational data analysis, comprising:
a computing device;
means for administering a plurality of diagnostic assessments to a student, each diagnostic assessment including a common set of concepts;
means for calculating growth potential of said student in each of said concepts by computing a difference between an expected proficiency percentage and a current proficiency percentage;
means for determining an expected performance for each concept on a future official assessment by assigning weighted factors to said plurality of diagnostic assessments;
means for determining a relevance of each concept to said future official assessment by utilizing factors of correlation of said concepts between subsequent official assessments and the frequency of testing of said concepts; and
means for prioritizing each concept according to performance growth, based on the Zone of Proximal Development, frequency of testing of said concepts and expected proficiency.

37. A method for educational data analysis, comprising:
administering a plurality of diagnostic assessments to a student, each diagnostic assessment including a common set of concepts;
calculating growth potential of said student in each of said concepts by computing a difference between an expected proficiency percentage and a current proficiency percentage;
determining an expected performance for each concept on a future official assessment by assigning weighted factors to said plurality of diagnostic assessments;
determining a relevance of each concept to said future official assessment by utilizing factors of correlation of said concepts between subsequent official assessments and the frequency of testing of said concepts; and
prioritizing each concept according to potential performance growth, based on a Zone of Proximal Development for the student, and a frequency of testing of said concepts;

38. The method according to claim 37, further comprising:
determining a relevance of each concept to an official assessment subsequent to said future official assessment.

39. The method according to claim 37, further comprising:
displaying a said set of concepts with a corresponding priority ranking for each concept to reflect concepts which have the most room for growth.

40. The system according to claim 20, further comprising:
means for displaying a list of students that are least proficient in a concept and for displaying a performance rating and a percentage of correct responses for said students.
